(19) United States
(12) Patent Application Publication
(10) Pub. No.: US 2026/0148720 A1
(43) Pub. Date: May 28, 2026

(54) DEVICE AND METHOD FOR CONTROLLING KEY UNITS

(71) Applicant: INVENTUS Engineering GmbH, St. Anton i.M. (AT)

(72) Inventors: Johannes Haag, Schruns (AT); Stefan Battlogg, St. Anton i.M. (AT)

(21) Appl. No.: 19/121,927

(22) PCT Filed: Oct. 16, 2023
(86) PCT No.: PCT/EP2023/078666

§ 371 Date: Apr. 17, 2025

(30) Foreign Application Priority Data
Oct. 17, 2022 (DE) 10 2022 127 137.4

(51) Int. Cl. G10H 1/34

(52) U.S. Cl. CPC G10H 1/34; G10H 2220/021

(57) ABSTRACT

A device, and method for using a device, with a controller, a memory, and an input unit. A plurality of key units for generating signals, being on the input unit. The key units each being moveable between at least two positions and configured for trigger a signal when moving from the first position to the second position. The key units have an associated electrically controllable brake device in order to brake a movement of the key units in a controlled manner. The brake device has two brake components which are movable relative to one another and between which an electrically controllable braking action is adjustable. The control apparatus is configured to specify an operating sequence of key units and adjusting a braking action for at least one key unit based on the operating sequence.

The present invention relates to a device and a method for controlling key units. Such a device can be designed, for example, as a musical instrument component or musical instrument or also as an operating device or, for example, a keyboard for a computer or a computer with an integrated keyboard or the like. Typically, such a device comprises a plurality of adjacently arranged key units which serve to generate signals or sounds. The key units are, for example, received on a common support body. The key units are typically movable between at least two positions and generate at least one signal at least when moving from the first position to the second position (directly or indirectly).

A wide variety of musical instruments, game controllers, computers and keyboards for computers have become known, which accordingly have a plurality or variety of key units. Experienced users can play pieces of music on musical instruments for their own enjoyment and for the enjoyment of others, and computer users can enter short or longer texts quickly and easily. The disadvantage, however, is that using keyboards for computers and especially playing musical instruments requires some practice. At least if the input of texts is to be quick and error-free or the musical experience when playing instruments is to be pleasant.

It is therefore the object of the present invention to provide a device and a method with which the operating keyboards for computers or other operating devices or playing pieces of music on musical instruments is supported and, in particular, is easier to learn.

This object is achieved by a device having the features of claim 1 and by a method having the features of claim 22. Preferred developments of the invention are the subject of the subclaims. Further advantages and features of the present invention emerge from the general description and the description of the exemplary embodiments.

A device according to the invention comprises at least one control device and a memory unit and an input unit on which at least a plurality of key units are accommodated for generating signals. The key units can each be moved (at least) between at least two positions over an actuation path. The key units trigger at least one signal at least when moving from the first position to the second position. At least one (electrically) controllable braking device is assigned to at least some key units in order to brake a movement of the key units (in particular individually) in a controlled manner. The control device is set up and designed to specify an actuation sequence of key units. Depending on the actuation sequence, a braking effect of at least one of the key units can be set (in particular with the control device).

The device according to the invention has many advantages. A significant advantage of the device according to the invention is that the control device can be used to predetermine an actuation sequence of the key units and that a particular (individual) control of the braking effect of the key units is generated accordingly. This makes it easier for the user to operate such a device. If the device is designed as a musical instrument, for example, or forms a musical instrument component of a musical instrument, the sequence of a piece of music can be specified and the user of the device or the player can feel the respective braking effect when pressing the key units.

The user receives direct feedback as to whether he is currently pressing the correct key unit or an incorrect key unit. The same applies when entering text or other characters into a computer using a keyboard, for example. In this case, too, the operator receives direct feedback as to whether he is using the keyboard correctly or is pressing the key units in the wrong order or at the wrong time.

In particular, the control device is designed and constructed to set an individual braking effect (direct or indirect) on the key units depending on the actuation sequence.

In all embodiments, an actuation sequence can be or represent, for example, a keyboard sequence or a piece of music or a game sequence, for example of a computer game. Accordingly, in a keyboard sequence, the sequence of characters can represent a meaningful text or a specific or random sequence of characters.

Basically, after the current key unit has been pressed, the next key unit to be pressed becomes the current key unit, depending on the sequence of operations. It is also possible, however, for the control to take place in a bar, whereby the “current key unit” is then the key unit that is currently being used in the sequence of operations. This is independent of whether the previous key unit was pressed correctly or at all. For example, in a piece of music, a note can be skipped that was accidentally pressed. was omitted. The user can then continue at the current correct point and, for example, take care of the omitted note on the next run.

In a preferred development, the braking device comprises at least two braking components that can be moved relative to one another, between which an electrically controllable braking effect can be set. Such a braking effect can represent or comprise a braking force or can also represent or comprise a braking torque. Accordingly, the braking effect can also comprise a braking force and a braking torque.

The controllable braking device can work in different ways. For example, an engine brake or a magnetic, hydraulic or pneumatic brake can be provided. It is also possible for a spring force to be generated or overcome via electrical activation, which brings two friction linings into contact with each other or separates them from each other.

Preferably, the braking device comprises at least one magnetorheological medium and can be subjected to a controllable magnetic field from at least one magnetic field generating device in order to set an electrically controllable braking effect. The braking effect can also be varied and/or controlled in particular in terms of time.

In advantageous developments, at least one braking device comprises at least one braking gap section which is (at least partially) equipped with the magnetorheological medium. It is preferred that the braking gap section is curved around a pivot axis of the braking device. It is also possible for the braking gap section to completely surround the pivot axis. In preferred developments, the control device is designed and constructed to set a freely adjustable course of the braking effect over the actuation path.

At this point, it should be noted that the term “actuating path” refers to both a path section to be covered and an angular movement or an angular section. This means that the term “actuating path” refers to both a linear movement and a “rotary movement” or a “swivel movement”.

In all embodiments, the strength of the braking and the course of the braking effect are preferably variable and/or individually adjustable. This results in a braking effect that is variable over the actuation path. In particular, the control device is designed and configured to apply a braking effect that is variable over the actuation path to a button unit.

It is preferred that the control device is set up and designed to set a braking effect curve over the actuation path for a key unit that is currently being actuated and to set a different braking effect curve for another key unit. This means that the key unit that is currently being actuated feels different when actuated than at least one other key unit. This allows the user to feel directly and immediately whether he is currently actuating the correct key unit. It is also possible for two or more key units to be current key units at the same time or slightly offset in time. For example, when playing a chord or when generating special characters on a keyboard.

Different key units can have a different progression of the braking effect (braking force, braking torque) over the travel path or actuation path. For example, the key unit to be actuated can have a first progression and a key unit that is not to be actuated can have a second progression. It is possible, for example, that a key unit is assigned a rectangular progression or a ripple with alternating strengths of the braking effect, while another key unit is assigned an increasing or decreasing progression of the braking effect. Other progressions in a zigzag or a sinusoidal progression or the like are also possible. The “braking effect” can also be understood as an “average” value over the travel path or a minimum or a maximum.

In all embodiments, it is also possible that the resistance of the key unit currently being operated is not lower, but higher than that of other key units that are not currently being operated. This also makes it possible to distinguish between key units that are currently being operated and key units that are not currently being operated.

The control device is preferably designed and set up to apply a lower braking effect to a key unit that is currently to be actuated due to the actuation sequence and to apply a greater braking effect to at least one other key unit (that is not currently to be actuated). It is conceivable that the key units arranged (directly or indirectly) in the vicinity of the key unit to be actuated are subjected to a different braking effect than the key unit currently to be actuated. In this respect, it is preferred that the control device is designed and set up to apply a different braking effect (and in particular a greater braking effect) to key units that are arranged immediately adjacent to or at a certain distance around a key unit that is currently to be actuated due to the actuation sequence. For example, only key units close to the key unit currently being operated may be subjected to a (different) braking effect, while key units further away remain unaffected. For example, the (one or two) key units adjacent to the current key unit in each direction may be subjected to a different braking effect than the current key unit. This can help to reduce energy consumption.

In all embodiments, it is preferred that at least some or all key units can be illuminated in a controlled manner using at least one lighting device. For example, an external lighting device can be provided which serves to selectively illuminate at least some or all key units.

It is particularly preferred that at least some key units or almost all or all key units each comprise at least one (own and separate) lighting unit. Such a lighting unit can in particular be integrated in at least some key units. Integrated or internal lighting units enable simple and reliable signaling of the next or current key unit. This also visually indicates to the user which key unit is to be pressed next. The key unit that follows can be illuminated in a different color rhythm and/or color tone.

In all embodiments, it is preferred that at least one display is included. Such a display can, for example, show an image of the plurality of key units. The control device is then preferably set up and designed to visually highlight the key units according to the actuation sequence. This can be done in addition to or instead of illuminating the key units to be actuated. A display can also be designed as a virtual reality display or one can be included in addition. It is also possible for a display to be designed on glasses. The glasses and/or the display can be designed to be partially transparent. A key unit can be selectively highlighted using such a display according to the sequence of operations. The control device is then particularly set up and designed to highlight the area of the display that is aligned with the next or currently operated key unit.

In all embodiments, it is preferred that the control device is set up and designed to detect an actuation of a key unit using the sensor device. This can be done using a sensor device that is assigned to a key unit. However, it is also possible for a camera, for example, to detect a movement of the actuation of the key units. In this case, a separate sensor device on the key units may be dispensed with.

Preferably, a plurality of sensor devices are provided for the plurality of key units in order to detect an individual actuation of the key units. It is also possible that only one common sensor device is provided for 2 or 3 separate key units if a (regularly) reliable assignment of the actuation or the sensor signal to a key unit is possible.

In all embodiments, it is particularly preferred that the control device is set up and designed to detect time intervals between the actuation of key units and to store them in the memory unit in order to enable direct and/or later evaluation. It is also possible that not only the time intervals of the actuation are recorded and are stored, but also that a temporal progression of the actuation of the (current) key units is stored in the memory unit. For example, an evaluation can be carried out directly via the times of the signals from the sensor device or the key units and/or via measured values from the sensor device.

The method according to the invention is carried out in particular using a device, the device comprising at least one control device and a memory unit and an input unit. At least a large number of key units for generating signals are preferably accommodated on the input unit. At least one electrically controllable braking device is preferably assigned to at least some key units. The key units can each be moved between at least two positions and trigger at least one signal when moving from the first position to the second position. An actuation sequence of key units is specified and a (particularly individual) braking effect of at least one of the key units is controlled depending on the actuation sequence. Such control is carried out in particular by means of the control device. The control device sets at least one (particularly individual) braking effect of the key unit currently to be actuated depending on the actuation sequence. In a simple case, a braking effect of the key unit (constant for the actuation period) is set. It is also possible to control the braking effect of the key unit over time.

The method according to the invention also has many advantages. The method makes it considerably easier to learn how to operate and operate such devices.

In particular, an actuation sequence of key units is specified and depending on the actuation sequence, the controllable braking device in order to specifically control a braking of at least one of the key units.

In advantageous further developments, a key unit is braked differently and in particular more strongly than a key unit that is currently to be actuated (according to the actuation sequence).

Preferably, all key units are braked differently and in particular more strongly (or weaker) than a key unit currently to be actuated according to the actuation sequence.

In advantageous embodiments, a key unit that is currently being operated is illuminated. The lighting can be provided by a central lighting system or by lighting integrated into the respective key units.

In all embodiments, it is particularly preferred that measured values are stored in the storage unit via the actuation. The recording can be carried out via separate sensor devices. However, it is also possible that the time of the signals is recorded directly or indirectly.

In preferred developments, measured values from the actuation of the key units are compared with specified values from the actuation sequence. This is a preferred aspect of the control. In a simple case, the measured value can be, for example, the correct actuation of a key. This can be a quasi-digital value, for example on a computer keyboard. In this way, the correct or the wrong key unit can be actuated. However, it is also possible to draw conclusions from the course of the actuation via the actuation path or the actuation angle. For example, the actuation speed or the volume of a played note or the like can be analyzed. In advantageous embodiments, measured values from different operating processes are compared with one another and at least one analysis value is determined and stored. For example, when writing a text or playing a piece of music, a comparison can be made with a previous process. In this way, an improvement or change over time can also be recorded and documented.

In particular, the method is carried out using a previously described device. The method can be used in particular to learn or improve the operation of the device. It is also possible to practice operating or playing with the device.

A particularly preferred method is used to learn how to operate a previously described device. In this case, an actuation sequence of key units is predetermined or can be set. Depending on the actuation sequence, at least one braking device is controlled and thus a braking effect (braking or braking intensity or braking force) of at least one of the key units is set in a time-controlled manner.

The applicant reserves the right to assert a claim to a storage medium containing a program with the process steps.

Further advantages and features of the present invention are described in the embodiments which are explained below with reference to the accompanying figures.

Showing:

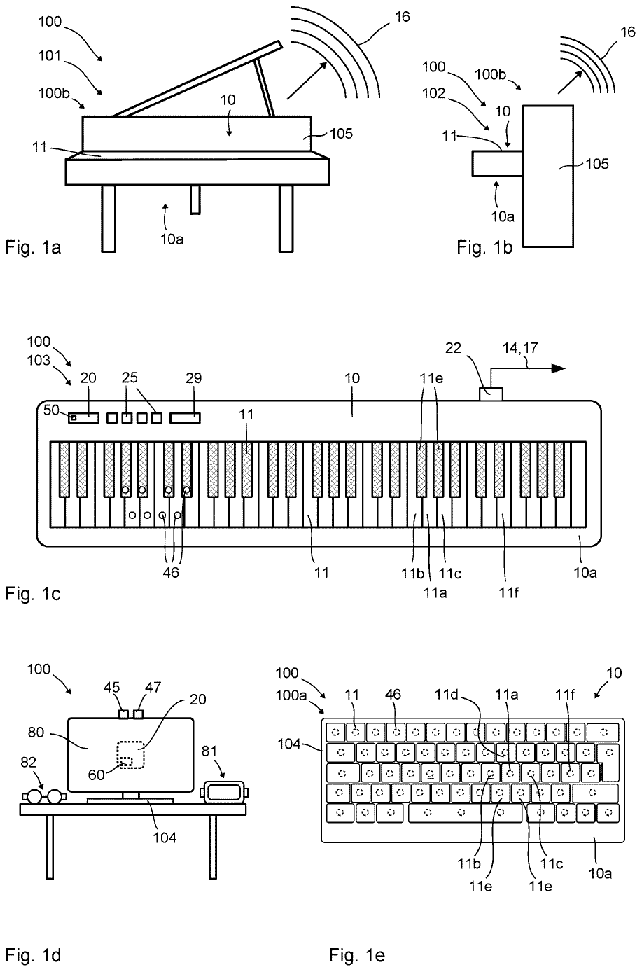

FIG. 1a-c shows various embodiments of devices according to the invention as musical instrument components;

FIG. 1d-e shows various embodiments of inventive devices comprising a keyboard;

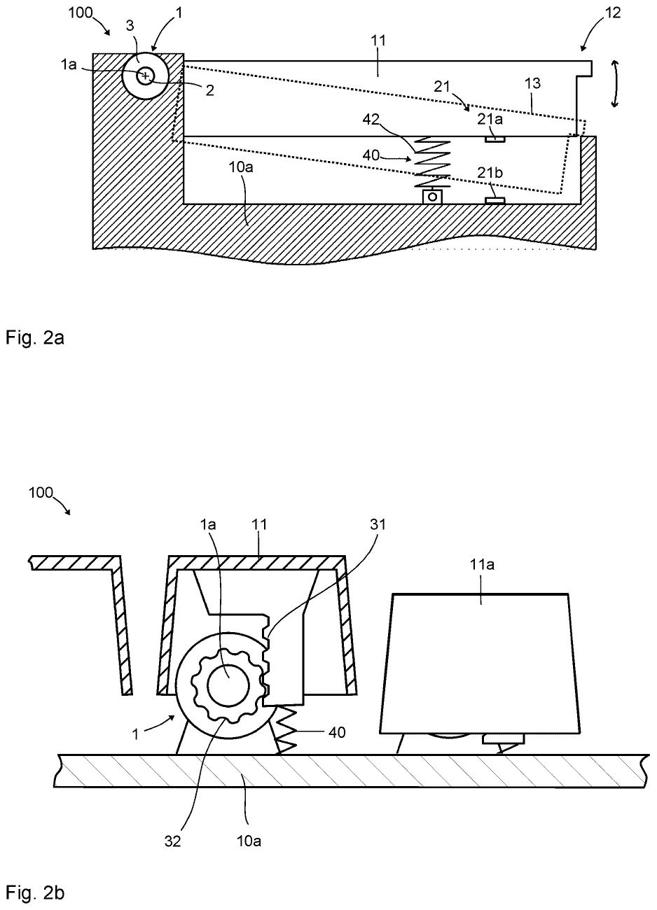

FIGS. 2a, 2b show highly schematic representations of devices according to the invention;

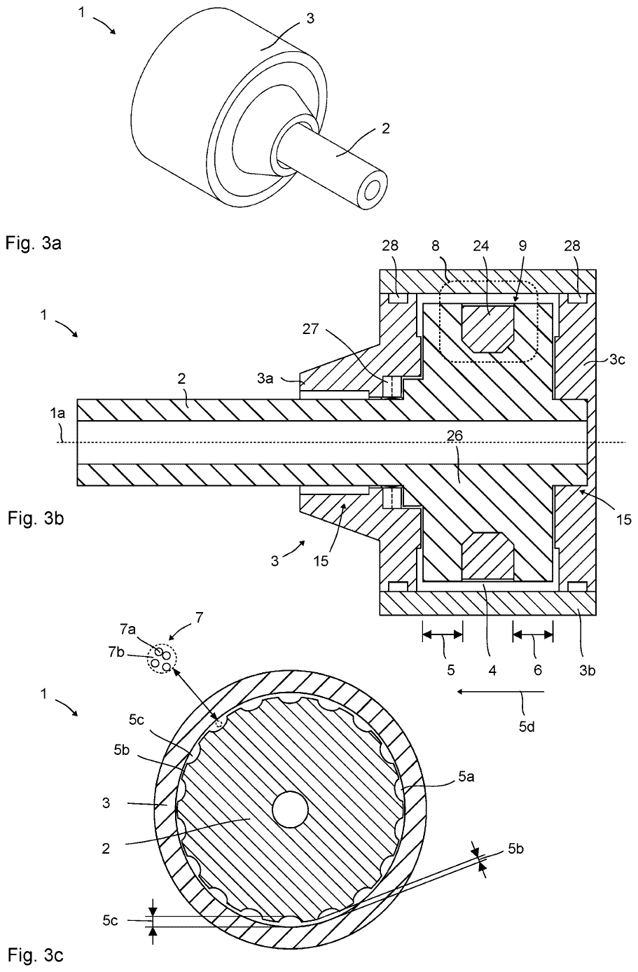

FIG. 3a-c show a perspective view and two sectional views of a braking device for a device according to the invention;

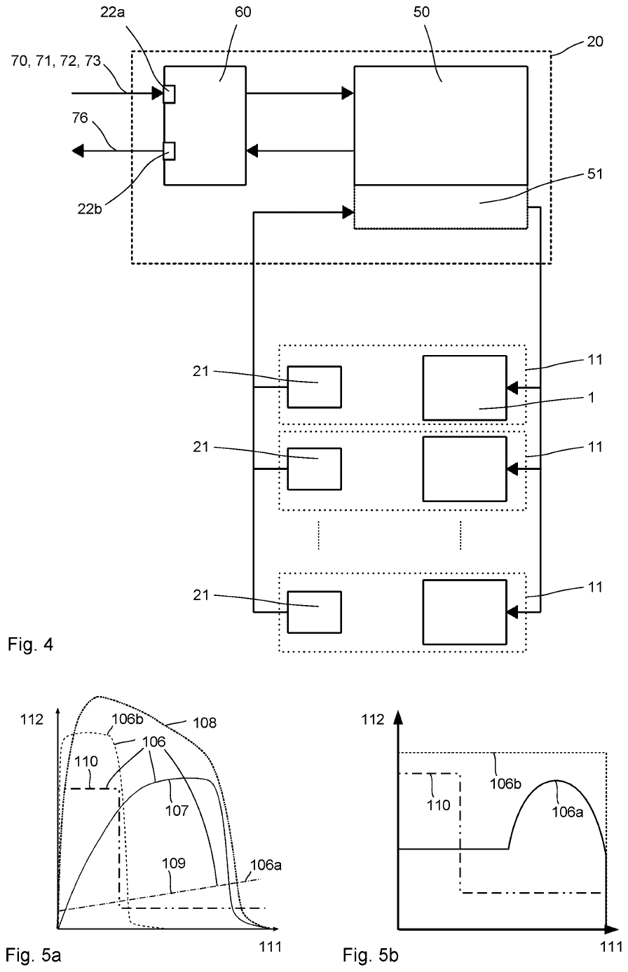

FIG. 4 is a schematic overview of a device according to the invention; and

FIG. 5a-b different courses of the braking effect over the actuation travel.

FIGS. 1a, 1b and 1c show three different embodiments of musical instrument components 100b according to the invention as devices 100. FIG. 1a shows a grand piano 101 as a musical instrument or musical instrument component 100b. The grand piano 101 has a keyboard (input unit 10) with a plurality of key units 11, which are here accommodated together on a support body 10a. The grand piano has a resonance body 105. When the key units 11 are actuated, tones 16 are output as signals 14.

FIG. 1b shows a piano 102 as a musical instrument component 100b, on which key units 11 on a keyboard are provided as an input unit 10. The key units 11 are also held here on a common support body 10a. A resonance body 105 is also provided. Not shown in FIGS. 1a and 1b are pedals that can be operated as required to change the sound properties.

FIG. 1c shows a keyboard 103 or a music keyboard, which also has a plurality of key units 11, which are arranged here in two levels. The respective key units 11 are movable on a support body 10a and here pivotably mounted. A control device 20 (and optionally an electronic control unit 50) can be mounted on the base body 10a or a housing, which are provided for controlling the magnetorheological braking devices and for further processing the signals generated.

Selector switches 25 for setting a desired characteristic or for switching on or off are also provided. A display 29 can be used for control. Either the signal 14 or the sound signal 17 generated by the control device 20 can be output and forwarded at a connection 22.

Via lighting units 46 integrated into the key units 11 (only some lighting units are shown schematically), one (or in particular each) key unit 11 can be illuminated from the inside (or also from the outside if necessary), so that the user immediately recognizes the key unit 11 to be actuated now and, if necessary, subsequently.

The characteristics when pressing the key units 11 can be set and changed specifically and individually for each key via the magnetorheological braking devices 1 arranged inside the housing (see FIG. 2). FIG. 1d shows a workstation with a table on which a computer with a control device 20 and a screen as a display 80 as well as a keyboard 104 are shown. In addition, a virtual reality display (VR display) 81 and glasses 82 with an integrated (e.g. partially transparent) display 80 are shown on the table.

The control device 20 or the computer comprises a storage unit 60 in which the program for the process sequence is stored. Here, a (central) lighting device 45 and a camera 47 can be seen at the top of the display 80. The lighting device 45 can be used for selective illumination of the individual key units 11 of the input unit 10. This visually indicates to the user which key unit is to be pressed next or currently.

The camera 47 can be used to record the key units 11 that are being operated. This can be done by recording which key unit 11 the user's finger is resting on. However, it is particularly preferred that the camera 47 and an image analysis are used to record the movement of the user's fingers when the key units 11 are operated, and that the measured values are then assigned and recorded.

FIG. 1e shows a schematic top view of a keyboard 104, which can be used together with a computer or separately. In this respect, the keyboard 104 can also form a device 100 or a device 100a. The keyboard 104 has a plurality of key units 11, which can be equipped here all or individually with a lighting unit 46 shown in dashed lines. A key unit 11 can be illuminated here from the inside or, if necessary, from the outside via the lighting unit 46, so that the user can immediately recognize the key unit 11 to be operated.

As an example, a key unit 11a that is currently to be operated or is to be operated next is shown, which is surrounded on the left and right by key units 11b, 11c. Key units 11d border on the top and two key units Ile border on the bottom of the current key unit 11a. The key units 11b to 11e form the key units arranged immediately adjacent to each other.

When carrying out the method according to the application, it is preferred that the current key unit 11a is provided with an individually set braking effect via the associated braking device 1 (compare FIGS. 2a, b and 3a-3c), while a different braking effect is set or controlled for the adjacent key units 11b to 11e. This is preferably carried out accordingly in other embodiments and, for example, also in the embodiment according to FIG. 1c.

The neighboring key units 11b to 11e are regularly provided with a greater braking effect (braking force and/or braking torque), while the key unit 11a is subjected to a lesser braking effect. The exact course of the braking effect over the respective actuation path and/or over time depends on the individual case. The key unit currently to be actuated can be subjected to both a stronger and a weaker braking effect.

FIG. 2a shows a possible embodiment of a key unit 11 on a musical instrument component 100b or device 100, which is shown very schematically and only partially, in a schematic section. The key unit 11 is held on a base body or support body 10a. The key unit 11 is held here so that it can pivot about an axis ha on the magnetorheological braking device 1. The key unit 11 is held here in an end region so that it can pivot about the pivot axis 1a. The first position 12, which is a rest position or starting position, is shown in solid lines. A pivoted second position 13 is shown in dashed lines.

To return the key unit 11 to the first position, which is a rest position, a return device 40 is provided, which here comprises a spring device 42 that is designed as a spiral spring. When the key unit 11 is actuated, the spiral spring of the spring device 42 is compressed so that after the key unit 11 is released, it is automatically returned to the first position 12. A sensor device 21 with a first sensor component 21a and a second sensor component 21b are used to detect a measurement for a position of the key unit 11. By evaluating the current position of the key unit 11 and the speed of movement and the rate of change of the acceleration, a signal 14 can be determined directly if necessary. In addition, the strength of the braking or the strength of the brake 1 is set via the current position of the key 11.

The magnetorheological braking device 1 here comprises an inner, fixed braking component 2 and an outer braking component 3 which can be pivoted relative thereto, which is arranged to be pivotable about the pivot axis 1a and which is connected to the key unit 11. However, it is also possible for the key unit to be fastened to a pivotable inner braking component 2 which is pivotably mounted on the fixed, outer braking component 3.

FIG. 2b shows a schematic cross-section through part of a keyboard 104 or the like, whereby three adjacent key units 11 can be seen at least in part on the device 100. Each key unit 11 is assigned a braking device 1, each of which has a pivot axis 1a. The course of the pivot axis 1a is aligned transversely and in particular perpendicularly to the direction of actuation of the key unit 11.

The actuation is transmitted to a toothing 32 on the braking device 1 via the teeth 31 on an extension of the key unit 11. This converts the linear movement of the key unit 11 into a rotary or swivel movement on the braking device 1. The necessary restoring force is provided by a schematically drawn restoring device 40, which generates a mechanical, magnetic or other restoring force. The key units 11 are mounted on a common support body 10a. As an example, the key unit 11 shown on the right is designed as the current key unit 11a and is shown schematically here in the pressed state.

FIGS. 3a, 3b and 3c show a preferred embodiment of the magnetorheological braking device 1. FIG. 3a shows a schematic perspective view. The inner braking component 2 and the outer braking component 3 are shown here. The two braking components 2, 3 are mounted so that they can pivot relative to one another.

FIG. 3b shows a longitudinal section. The inner brake component 2 here can, for example, be designed to be stationary. In the hollow part of the inner brake component 2, for example, cables for the power supply (not shown) and cables to any sensors that may be present can be passed through. Here, the inner brake component also forms the core 26, around which the electrical coil unit 24 is wound in a circumferential groove or the like.

The magnetic field generating device 9 here comprises the electrical coil unit 24 and the core 26 and can optionally also comprise a permanent magnet which, for example, provides a basic torque even when there is no current. During operation, the magnetic field of the permanent magnet (not shown here) can then be either strengthened or weakened by supplying current to the electrical coil unit 24 in order to generate a time-dependent or path-dependent magnetic field and thus braking torque.

As an example, FIG. 3b shows the course of a magnetic field 8 which passes approximately radially through the brake gap sections 5 and 6 of the brake gap 4 adjacent to the electrical coil unit 24. As a result, a (variable) braking torque is generated in the braking gap sections 5 and 6, which depends on the strength of the magnetic field.

The braking gap 4, which is part of a receiving space, is at least partially filled with a magnetorheological medium, so that the braking gap sections 5 and 6 each contain magnetorheological particles which are influenced by the magnetic field 8.

The brake component 3, which here radially surrounds the brake component 2, comprises a housing with a front part 3a, an outer part 3b and a rear part 3c. Overall, the outer part 3b and the core 26 consist of a material with good magnetic conductivity, so that an effective magnetic field 8 can be generated. The other parts 3a, 3c preferably consist of a material with a (significantly) lower magnetic conductivity than the outer part 3b (preferably a factor of >10). A sealing means 28, e.g. a housing seal made of an elastomer, is arranged between the front part 3a and the outer part 3b and between the outer part 3b and the rear part 3c.

At least one rotary bearing 15 can be provided or formed between the two brake components 2 and 3. It is also possible that no separate bearing is provided, but rather the magnetorheological braking device 1 provides a rotary bearing 15.

FIG. 3c shows a cross-section through the magnetorheological braking device according to FIG. 3b, where the structure of the brake gap section 5a can be seen. Here, the inner brake component 2 has an outwardly projecting star contour or toothing in the area of the brake gap section 5, while the outer brake component 3 has a cylindrical inner wall. This results in a gap height 5a that is variable over the circumference between the two brake components 2, 3. with periodically alternating minimum gap heights 5b and maximum gap heights 5c. Here, the two brake components 2, 3 are each formed uniformly in the axial gap direction 5d over the brake gap section 5 or 6.

The brake gap section 5 or 6 each has a variable gap height 5a, the variation of which amounts to up to 1%, 2% or 5% of the diameter of the brake gap section 5. Larger and smaller gap heights are also possible. The brake gap preferably contains magnetorheological particles whose particle diameter is considerably smaller than the minimum gap height. The maximum particle diameter of the magnetorheological particles 7a is preferably smaller than ⅕ or 1/10 or 1/100 of the minimum gap height 5b. However, other dimensions of the magnetorheological particles 7a are also possible. The magnetorheological particles 7a are surrounded by a filling medium 7b, which can be a gas, so that dry magnetorheological particles 7a are present in the brake gap 5 or 6. However, it is also possible for an oil or another fluid to be used as a carrier medium.

Depending on the desired braking effect, the electrical coil unit 24 is controlled. The strength of the braking effect can be increased or decreased considerably within a few milliseconds.

FIG. 4 shows a highly schematic diagram, with the control device 20 shown in dashed lines in the upper part, which comprises, for example, a control unit 50 and a storage unit 60.

The control device 20 includes a comparison device 51. An actuation sequence 70, for example in the form of a keyboard sequence 71 or as a piece of music 72 or as a game sequence 73, for example of a computer game, is entered into an input 22a of the control device 20 and stored in the memory unit 60. Analysis data 76 can be output via the output 22b and displayed, for example, on the screen or display 80 in order to also allow a visually simple analysis.

According to the actuation sequence 70, a key unit 11a to be actuated is specified, to which a braking device 1 is assigned. The desired braking effect is set or timed on the key unit 11a and a correspondingly different one is set or timed on all the others or on the surrounding key units 11b to 11e.

A sensor device 21 detects the actuation of the key unit and returns this to the control device 20, where a comparison is carried out in the comparison device 51. The result of this is included in the analysis data 76.

FIG. 5a shows various set or predetermined curves 106 of the braking effect 112 over the actuation path 111. The respective curves 106 can be set individually and depend, for example, on the device 100a or the musical instrument 100b. The actuation force over the path or the swivel angle for different musical instruments is, for example, different.

When pressing a key unit 11, different forces must be applied to different instruments, but even with the same instrument, the force curve depends on the speed at which the key is pressed. In addition, an adapted control is provided.

Curve 106b shows the force curve of a harpsichord, curve 107 the force curve of a concert grand piano 101 and curve 109 the force curve of a music keyboard. Curve 107 shows the force curve at a first lower speed of the key unit 11.

In a concert grand piano, the lying hammer must be accelerated towards the string. Since this is a rotary movement, the necessary force is initially increased until the hammer is released from the mechanism (so-called release) and only strikes the string with its impulse. From the point of release onwards, the force required for further movement drops, the user only feels (in a “real” concert grand piano—and simulated here) the friction of the mechanism until the key unit hits the stop (end position). There the movement is slowed down or dampened (in reality—and here virtually) by a felt or similar so that the key unit does not hit hard. Real pianos (upright pianos, in contrast to grand pianos) have a slightly different force curve, since the hammer does not lie down, but stands. This can also be simulated on request.

A harpsichord, on the other hand, “plucks” the strings with a spring. This means that a greater force must be applied at the beginning to pull the spring past or over the string. As soon as the string has been plucked by the spring, the force decreases almost completely, so that the rest of the way the key unit is moved without force. Here, too, the course can be adjusted accordingly.

A music keyboard or a keyboard 104 usually has only one spring as a return element and key units (usually made of plastic) that have little mass and thus little inertia. Therefore, the force required to move the key is determined by the spring characteristic of the return spring device, which can also be simulated.

Basically, the different curves 106 show possible force curves for different input units or musical instruments. The force curve for a key unit 11a that is currently being operated can also depend on the type and intensity of a note to be played. Curve 107 can represent the force curve of a reference curve, while curve 108 shows the curve when the key is struck too hard, for example.

Depending on whether a “correct” current key unit 11a or an “incorrect” one—for example, an adjacent key unit 11b—is operated, the force curve is set differently. For a key unit 11a of a keyboard 104 that is currently to be operated, for example, the force curve 109 can be set as the current force curve 106a, while for an adjacent key unit 11b a different force curve 106b is set that requires considerably higher actuation forces, so that the user receives immediate feedback.

FIG. 5b shows, purely by way of example, a force curve 110 when a keyboard 104 is operated. Two curves 106a and 106b are also shown, with curve 106a representing, for example, a current curve of the key unit 11a that is currently being operated, while curve 106b is intended for a key unit 11 that is not currently being operated. It is immediately apparent that, at least at the start of the operation, the braking effect for a key unit 11a that is currently being operated is considerably lower than the braking effect for a different curve 106b for a key unit that is not currently being operated. Therefore, the user can immediately tell when operating whether he has operated the correct key unit or not.

The setting of the braking effect curves can also be made depending on the type of device present or simulated. For example, in the case of musical instruments, the key unit currently being played can be simulated with a force curve that corresponds to a real instrument. For key units that are not currently being operated, a correspondingly different curve 106b can be selected. If the If a piece of music is played completely correctly, the player doesn't notice anything. If the wrong key unit is played, the player immediately realizes that he is not playing correctly due to the changed braking effect.

Overall, the invention can be used in various devices and in the context of various methods. For example, it is possible that only certain key units of a device 100 can be pressed, depending on where one is in the song or in a text or in an actuation sequence 70 to be entered. It is possible to combine such a learning program with virtual reality, for example. The user can then see directly via VR glasses or glasses with a built-in display which key unit he should press or play next. Additional visual aids can also be attached to the key units or the key units can be illuminated accordingly. For example, LEDs can be integrated that light up when the respective key unit is currently to be pressed.

In all versions, it is possible for teachers to send students or users pieces or tasks that they should practice. The transfer can be done via a storage medium or as a file by email or directly via a network connection or in some other way. The users or students can then enter these via the input interface. The analysis data that they collect when operating or playing or completing the tasks can be saved and evaluated or read out for analysis. This allows the teacher to see what the user or student has practiced and where there are still weaknesses or areas for improvement.

In all versions, the key units can be individually adjusted to a different degree of hardness or stiffness for each finger. For example, less force may be useful or necessary when operating with a little finger than when operating with a thumb or index finger. Accordingly, a distinction can also be made between the left and right hand, even for different users.

The actuation force or the actuation moment of the key units can then be set according to the fingering of a song or depending on the distance from a starting position “asdf” or “hj kl” of the fingers on a complete computer keyboard. Using additional sensor devices such as a camera with image recognition or the like, it can be determined which finger is pressing a key unit.

List of Reference Symbols:

1. braking device
2 first brake component
3 second brake component
3a front part
3b exterior part
3c rear part
4 braking gap
5 braking gap section
5a gap height
5b minimum height of 5
5 c maximum height of 5
5d axial gap direction of 5
6 braking gap section
7 magnetorheological medium
7a magnetorheological particle
7b filling medium
8 magnetic field
9 magnetic field generation
10 input unit
10a support body
11 key units
11a-f key unit
12 first position
13 second position
14 signal
15 rotary bearing
16 tone
17 sound signal
20 control device
21 sensor device
21a sensor component
21b sensor component
22 connection
22a input
22b output
24 electric coil unit
25 switches
26 core
27 sealing device
28 seal
29 display
31 teeth on 11
32 teeth on 1
40 restoring device
45 lighting device
46 lighting unit
47 camera
50 control unit
51 comparison device
60 memory unit
70 actuation sequence
71 keyboard sequence
72 music piece
73 game sequence
76 analysis data
80 display
81 vr display
82 glasses
100 device
100a device
100b musical instrument
101 grand piano
102 piano
103 keyboard, music keyboard
104 keyboard
105 resonance body
106 curves
106a current curve
106b other curve
107 force curve of 101
108 force curve of 101
109 force curve of a music keyboard
110 force curve (keyboard)
111 actuation path (path, angle)
112 braking effect (force, moment)

1-29. (canceled)

30. A device, comprising:
at least one controller, a memory, and an input unit;
a plurality of key units on said input unit for generating signals;
said plurality of key units each being movable between at least a first position and a second position via an actuation path, and each being configured to trigger at least one signal when moving from said first position to said second position;
at least one electrically controllable braking device configured to brake a movement of at least one key units of said plurality of key units in a controlled manner; and
said controller being configured to specify an actuation sequence of said plurality of key units and a braking effect of at least one of said key units being set depending on said actuation sequence.

31. The device according to claim 30, wherein said at least one braking device has a magnetorheological medium and is configured to be subjected to a controllable magnetic field of at least one magnetic field generating device to set an electrically controllable braking effect.

32. The device according to claim 31, wherein said at least one braking device has at least one braking gap section which is at least partially filled with said magnetorheological medium.

33. The device according to claim 32, wherein said braking gap section is curved around a pivot axis of said braking device.

34. The device according to claim 30, wherein said controller is configured to set a freely adjustable course of said braking effect over said actuation path.

35. The device according to claim 34, wherein said controller is configured to set a course of said braking effect over said actuation path for a key unit of said plurality of key units that is to be actuated and a different course of said braking effect that differs from this for another key unit of the plurality of key units.

36. The device according to claim 30, wherein said controller is configured to apply a lower braking effect to a key unit of said plurality of key units that is to be actuated due to said actuation sequence and to apply a greater braking effect to at least one other key unit of said plurality of key units.

37. The device according to claim 34, wherein said controller is configured to apply a different course of said braking effect to key units of said plurality of key units that are arranged adjacent to a key unit that is to be actuated due to said actuation sequence.

38. The device according to claim 34, wherein said controller is configured to apply a different course of said braking effect to all key units that cannot be actuated due to said actuation sequence.

39. The device according to claim 30, wherein at least two key units of said plurality of key units can be illuminated in a controlled manner using at least one lighting device.

40. The device according to claim 30, wherein at least two key units of said plurality of key units each have at least one lighting unit.

41. The device according to claim 40, wherein said controller is configured to illuminate a key unit of said plurality of key units that is to be actuated based on said actuation sequence.

42. The device according to claim 30, further comprising at least one display.

43. The device according to claim 42, wherein an image of said plurality of key units can be displayed on said display, and said controller is configured to optically highlight said key units according to said actuation sequence.

44. The device according to claim 42, wherein said at least one display is a VR display or a display on glasses, and said display optically highlights key units selectively according to said actuation sequence.

45. The device according to claim 30, further comprising at least one sensor.

46. The device according to claim 45, wherein said controller is configured to detect an actuation of a key unit with said sensor.

47. The device according to claim 46, wherein said at least one sensor includes a plurality of sensors provided for said plurality of key units to detect an individual actuation of said key units.

48. The device according to claim 45, wherein said controller is configured to detect a speed of actuation of at least one key unit with said sensor.

49. The device according to claim 45, wherein said controller is configured to store measured values of said sensor in said memory to enable later evaluation.

50. The device according to claim 30, wherein said controller is configured to detect time intervals of actuation of key units and store said time intervals in said memory to enable later evaluation.

51. A method, comprising:
providing a device having
at least one controller, a memory and an input unit,
a plurality of key units, on the input unit, for generating signals, the key units each being movable between a first position and a second position, and
at least one electrically controllable braking device configured to brake a movement of at least one key unit of the plurality of key units;
triggering at least one signal at least when a key unit of the plurality of key units is moved from the first position to the second position;
predetermining an actuation sequence of key units of the plurality of key units;
controlling the controllable braking device based on the actuation sequence to control a braking of at least one of the key units.

52. The method according to claim 51, wherein key units are braked differently than a key unit that is currently being actuated.

53. The method according to claim 51, wherein all key units are braked differently than a key unit that is currently being actuated.

54. The method according to claim 51, wherein a key unit that is currently being actuated is illuminated.

55. The method according to claim 51, wherein measured values based on the actuation of the key units are stored.

56. The method according to claim 55, wherein the measured values from the actuation of the key units are compared with preset values from the actuation sequence.

57. The method according to claim 51, wherein measured values from different operating processes are compared with one another and an analysis value is determined and stored.

58. A method for learning how to operate a device, the method comprising:
providing a device according to claim 30;
specifying an actuation sequence of key units;
controlling at least one braking device based on the actuation sequence; and
setting a braking effect of at least one of the key units in a time-controlled manner.
